(19) United States
(12) Patent Application Publication
(10) Pub. No.: US 2002/0165831 A1
(43) Pub. Date: Nov. 7, 2002

(54) Electronic payment method and system for carrying out the same

(76) Inventors: Michael Horn, Muenchen (DE); Hans-Hermann Wolf, Muenchen (DE)

Correspondence Address: BELL, BOYD & LLOYD, LLC, P. O. BOX 1135, CHICAGO, IL, 60690-1135, US

(21) Appl. No.: 09/980,258

(22) PCT Filed: Mar. 30, 2001
(86) PCT No.: PCT/DE01/01219

(30) Foreign Application Priority Data
Mar. 31, 2000 (DE) 100 16 246.0

(51) Int. Cl. G06F 17/60

(52) U.S. Cl. 705/77

(57) ABSTRACT

An electronic payment method for paying for merchandise or a service offered by a vendor and ordered by a purchaser over a data or telecommunication network using a prepaid electronic credit, essentially in real time, over the network, where a predetermined credit sum required for paying for the merchandise or service is transferred, in response to a transfer signal transmitted by a first terminal associated with the purchaser, to an electronic interim account belonging to the purchaser, in particular after intervening transfer by a debit signal, to an electronic target account belonging to the vendor.

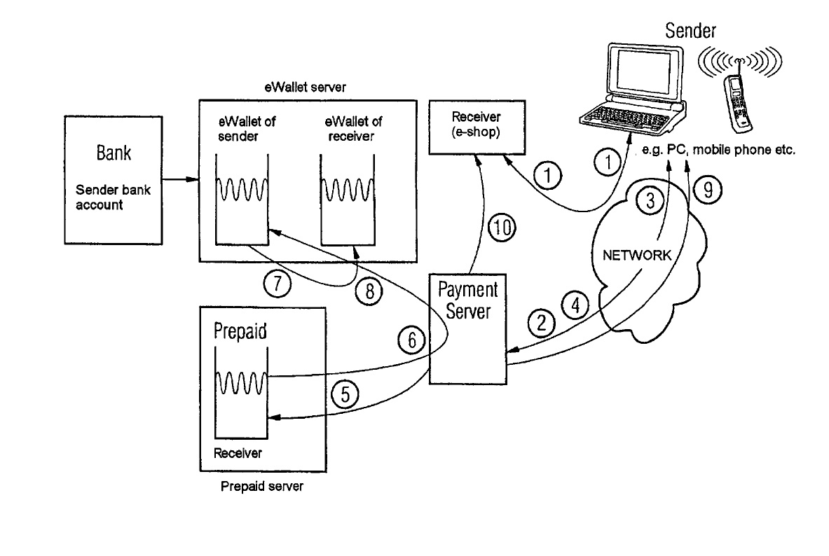

The invention relates to an electronic payment method for paying for merchandise or a service over a data network which can essentially proceed in real time, and to a corresponding arrangement.

Besides for use as a means of communication and a source of information for what has now become hundreds of millions of people, the Internet is becoming increasingly important as a source of shopping. Particularly trade in software, books and travel is already being carried out on the Internet in a significant proportion today, but also a broad spectrum of other goods and services is increasingly being ordered and paid for over the Internet. Paying for the relevant services on the Internet in the manner which was established originally and is still generally widespread today requires the relevant data records to be entered separately in each case, at least by each party to the transaction, if not even for the individual transaction. This mode of payment thus allows the party to the transaction to see sensitive personal data and even to store them permanently.

The Internet has now also become considerably important for handling other payment operations in the business and private sectors. Virtually all banks in industrial states offer electronic handling of account management and of payment operations in the form of “electronic banking”.

Nevertheless, the majority of payment operations in day-to-day life are, even today, still performed using cash or by providing transfer or direct debit orders or the like in writing, or by credit card or check card. In specific areas, for example that of mobile radio technology, electronic credits (“prepaid cards”) have also become significant, but considerable obstacles prevent this means of payment from being introduced on a widespread basis.

Altogether, it can be stated that, in the current state of development, there are an extremely confusing large number of options for paying for goods or services, and using said options in day-to-day life requires considerable alertness and requires a wide variety of media and modes of entry to be dealt with. This is demanding and is also associated with diverse security risks (losing data media or credit media, forgetting account data and authentication codes etc.).

Besides the Internet, telecommunications—in particular mobile telecommunications—today represents an area of rapid technical and economic development and a significant source of economic growth and new social developments. For a large number of the people in industrial states, the mobile telephone (“mobile”) is increasingly becoming a universal communication and information instrument and is also increasingly being used to access goods and services. This development is also still hindered by insufficient opportunities for reliable and at the same time simple payment for information, goods and services ordered using a mobile.

Although solutions exist which allow the user of a mobile—with or without a prepaid card—to authorize payments, which are then processed in a conventional manner by debit procedures or credit card debiting, these methods presuppose, as do payment processing procedures which have now been introduced on the Internet, that the purchaser is creditworthy and has authority to use a credit card or a current account with an overdraft facility. In addition, these procedures have inherent time lags which have a disadvantageous effect on the transparency and reliability of the overall processing.

The invention is therefore based on the object of specifying a method and an arrangement for simplified processing of payment transactions using a data network.

This object is achieved in terms of its method aspect by a method having the features of claim 1, and in terms of its apparatus aspect by an arrangement having the features of claim 10.

The invention encompasses the fundamental concept of using a prepaid electronic credit (the term “prepaid” having been introduced on a general basis), such as is already in widespread use today for paying for mobile radio services. It also encompasses the concept of transferring part of such a prepaid credit, which may be implemented on a special smart card or else on another memory in a telecommunication or data network, to an electronic target account belonging to a supplier of merchandise or a service to the amount of a sum required for paying for the merchandise or service.

From the point of view of the greatest possible security for the customer or purchaser, and bearing in mind legal provisions for the banking industry, an intermediate step of transfer to an electronic interim account belonging to the purchaser is performed in this context.

The method can be used, in particular, for payment processing in the B2C (Business-to-Consumer) sector and in this case particularly for shopping in virtual shops and for “micropayments” or content charging (paying minimal sums for information/pieces of music or the like) on the Internet, but in principle also for paying for goods in real shops or for services in the field of catering, culture or sport and also for using merchandise dispensing machines.

As a real-time method, the proposed method affords improved transparency and reliability as compared with known payment processing methods. In addition, it can also be used, in particular, by people who have not been granted a credit facility. The user need merely have a prepaid credit ensuring sufficient coverage of the envisaged transfer of money. Another important advantage, particularly for users of electronic commerce (e-commerce or m-commerce) who have relatively low income, is the good cost control.

In the description below and in the patent claims, the holder of the prepaid credit wishing to transfer a sum of money and entering a (real or virtual) shop as a purchaser and entering a catering establishment as a guest is referred to as the “purchaser”. The receiver of the sum of money to be transferred is referred to below as the “vendor”. In addition, receivers and senders of money may also be applications.

In the preferred embodiment of the proposed solution, the prepaid electronic credit is managed on a special server in the data network or—in particular—a telecommunication network which can be connected thereto, specifically independently of its physical appearance to the user (card, terminal with a permanently built-in memory, or the like). This server is also referred to below as the prepaid server in order to illustrate its function graphically.

This is advantageous to the extent that, for this embodiment, an established infrastructure already exists in the mobile radio networks and with the providers, and broad user groups are already well versed in the use of prepaid credits in the mobile radio sector. In principle, prepaid credits can also be used in the landline network, however.

The target account of the vendor is expediently managed on an account management server implemented directly in the data network used as the basic infrastructure—that is to say, in practice, on the Internet. The interim account of the purchaser is also managed on such an account management server, possibly on the same one as the target account of the vendor. The latter variant simplifies the connection setup and data transfer which are required for the transactions. In practice, however, it is more likely to be the exception on account of the wide variety of service providers on the market. The account management server(s) is (are) also referred to as (an) eWallet server(s) below, on account of its (their) function of providing an “electronic wallet”.

The functions required for processing the transaction are provided by a special application server which, on the basis of its special function, can be referred to as the payment server. The connecting and checking operations crucial for performing the transaction are also carried out on the payment server. These procedures have a multiplicity of conceivable variants which are described in the explanations below merely using examples which are advantageous from today's angle, but are not dealt with exhaustively.

A central function of the payment server is to check authentication and/or account data, transmitted by the purchaser when initiating the transaction, on the basis of customer data stored in the network—specifically in the home location register (HLR) of a mobile radio network. Another fundamental checking function is checking the current level of the prepaid credit with respect to the sum which needs to be transferred to pay for the required merchandise or service. Within the context of setting up the connections required for the transaction, the payment server sets up, in particular, a connection to the prepaid server in order to ascertain the existence of a prepaid credit and the level thereof on said prepaid server. It also sets up a connection or connections to the eWallet server or eWallet servers on which the interim and target accounts are managed, in order to use these connections to transmit the data to implement the electronic transfer operation. Finally, the payment server needs to maintain the telecommunication link (originally set up from the terminal of the purchaser)—and possibly set it up again in order to transmit a completion acknowledgment—for the purposes of data entry under menu guidance, and optionally also needs to set up a connection to the terminal of the vendor in order to transmit a completion acknowledgment to him.

In addition, the payment server runs the software for controlling communication with the terminal of the purchaser, in particular under visual or voice-controlled menu guidance, and—optionally—with the terminal of the vendor, in particular for the purposes of transaction acknowledgment.

The explanations above also reveal the fundamental functional components of an arrangement suitable for implementing the invention, which means that it is not necessary to describe the arrangement aspects of the invention in detail again at this point. In particular, it is evident that, besides the fundamental network infrastructure—in particular a combined data and telecommunication network—it is necessary to have servers on which the prepaid credit and the accounts and the application software are managed, and the purchaser needs to have a terminal for initiating the transaction and for entering the relevant data.

In terms of the number of servers performing the transaction and their division of functions, however, the conceivable variants are just as different as for involving the vendor (with or without a separate terminal) in the actual payment operation and for the components used for acknowledging payment.

A preferred embodiment is described in more detail below with reference to the single figure, the individual steps being symbolized in the figure by circles containing numerals. In contrast to the names above, in this case the purchaser is referred to as the “sender” and the vendor—in this case as the operator of a virtual shop e-shop—is referred to as the “receiver”. A combined telecommunication and data network is simply referred to as NETWORK in this case. The interim account of the purchaser (sender) and the target account of the vendor (receiver) are each referred to as an eWallet. The other names are in line with the explanations of terms given further above.

The sequence of the method is as follows:

1. The sender uses his mobile radio terminal to set up a connection to the receiver (e.g. e-shop), whose merchandise is held on a merchandise server and is handled using a data terminal associated with the vendor, and wishes to take advantage of (purchase) the product(s) on offer.

2. After the product(s) has (have) been selected and the desire to make a purchase has been confirmed (by data communication between the terminals of the purchaser and of the vendor), in which case the receiver has notified the sender of his eWallet account number, a connection is automatically set up between the sender and the payment server. In this process, the eWallet account number of the receiver is also transmitted to the payment server.

3. Menu guidance displayed on the sender's terminal display or else conveyed in audible form requests the sender to authenticate himself with the payment server. By doing this, the accounts of the sender can also be clearly identified.

4. Since the sender has a prepaid account, he is offered prepaid as a payment option. The sender decides on prepaid and enters the payment sum.

5. The payment server checks with the prepaid server to determine whether the prepaid account indicated exists and whether the sum indicated is available in the account.

6. If this is the case, the sum is transferred to the eWallet account of the sender on the eWallet server.

7./8. Next, the sum is debited from the eWallet account of the sender, and the sum is credited to the eWallet account of the receiver. (The intermediate step using the eWallet account of the sender may possibly be omitted. The intermediate step is particularly useful when an existing electronic payment method on the Internet which, by way of example, uses special coding methods to produce electronic coins, is to be involved). Money is transferred in real time.

9. The sender receives an acknowledgment about the successful transfer of money.

10. The receiver is informed about the receipt of the sum of money in his eWallet account.

1. An electronic payment method for paying for merchandise or a service offered by a vendor and ordered by a purchaser over a data or telecommunication network using a prepaid electronic credit, essentially in real time, over the network, where a predetermined credit sum required for paying for the merchandise or service is transferred, in response to a transfer signal transmitted by a first terminal associated with the purchaser, to an electronic interim account belonging to the purchaser, in particular after intervening transfer by a debit signal, to an electronic target account belonging to the vendor.

2. The payment method as claimed in claim 1,
characterized in that
the prepaid electronic credit is managed on a credit management server in the data network or in a telecommunication network connected thereto, and a piece of credit transfer software is implemented on an application server in the data network or telecommunication network.

3. The payment method as claimed in claim 1 or 2,
characterized in that
the interim account is managed on an account management server in the data network.

4. The method as claimed in one of the preceding claims,
characterized in that
the target account is managed on an account management server in the data network, in particular on the same account management server as the interim account.

5. The method as claimed in one of claims 2 to 4,
characterized in that,
after the merchandise or service has been ordered, in particular automatically in response to an acknowledgment signal fixing the order, a connection is set up between the first terminal and the application server;
after the connection has been set up, an account identifier for the target account of the vendor, an authentication code and/or an account identifier for the interim account and a credit identifier for the prepaid credit of the purchaser and also the predetermined credit sum are transferred to the application server,
these data are checked after they have been received on the application server,
if the result of the check is positive, the credit sum is transferred from the prepaid credit to the interim account of the purchaser and from the latter onward to the target account of the vendor, and a log record of the transfer operations is created.

6. The payment method as claimed in claim 5,
characterized in that
it is carried out as a combined mobile radio and data transfer, the entries by the vendor being made in the form of keyboard or voice entries on a mobile radio terminal under menu guidance provided by the application server.

7. The method as claimed in claim 5 or 6,
characterized in that
a respective acknowledgment signal about completion of the electronic transaction is transmitted to the purchaser and to the vendor after a transfer has been made.

8. The payment method as claimed in one of the preceding claims,
characterized in that
the electronic interim account of the purchaser is provided within the context of the subscription to a shopping service, in particular with an operator of the account management server, where the purchaser is allocated an authentication code.

9. The payment method as claimed in claim 8,
characterized in that
the allocated authentication code simultaneously represents the credit identifier for the prepaid credit and the account identifier for the interim account.

10. A data transmission arrangement for paying for merchandise or a service offered by a vendor and ordered by a purchaser over a data network using a prepaid electronic credit, essentially in real time, over the data network, which arrangement has:
a credit memory, managed on a credit management server, for storing the prepaid electronic credit, an interim account memory on an account management server,
a target account memory on the account management server or on a further account management server, a piece of credit transfer software implemented on an application server,
a first terminal associated with the purchaser for entering credit and account identifiers and a payment initiation signal, and a data or telecommunication network connection between the first terminal, the credit management server, the account management server or account management servers and the application server in order to implement a data transfer process, implementing an electronic transfer, between these elements.

11. The data transfer arrangement as claimed in claim 10,
characterized in that
the first terminal of the purchaser [lacuna] a mobile radio terminal connected to a mobile radio network, and the prepaid credit is stored on a prepaid card of the mobile radio network.

12. The data transfer arrangement as claimed in claim 10 or 11,
characterized by
a second terminal associated with the vendor, in particular a data terminal, which is connected to the data network directly or via a telephone landline network, for receiving the payment initiation signal and optionally an acknowledgment signal about completion of the electronic payment operation.

13. The data transfer arrangement as claimed in one of claims 10 to 12,
characterized in that
the application server has an authentication code memory and a comparator unit, connected thereto at the input, for comparing an authentication code, received from the first terminal, with a stored authentication code and for outputting an enable signal for the payment operation if there is a match between the two.

14. The data transfer arrangement as claimed in claim 13,
characterized in that
the application server has a decoding unit for obtaining a credit and/or account identifier for the prepaid electronic credit or for the interim account from the authentication code.
